(19) United States
(12) Patent Application Publication
(10) Pub. No.: US 2017/0270969 A1
(43) Pub. Date: Sep. 21, 2017

(54) REAL TIME COMPUTER DISPLAY MODIFICATION

(71) Applicant: Jose M. Sanchez, Morgan Hill, CA (US)

(72) Inventor: Jose M. Sanchez, Morgan Hill, CA (US)

(21) Appl. No.: 15/456,409

(22) Filed: Mar. 10, 2017

Related U.S. Application Data
(60) Provisional application No. 62/309,889, filed on Mar. 17, 2016.

(51) Int. Cl. G11B 27/034; G11B 31/00; H04N 5/225; G11B 27/34

(52) U.S. Cl. CPC G11B 27/034; G11B 27/34; G11B 31/006; H04N 5/2252

(57) ABSTRACT

A video system generates edited video. A camera on a personal computing device captures both a captured image and captured video. An image editor includes editing tools by which a user can edit the captured image. A video editor is configured to edit captured video in real time by the video editor to produce the edited video. Edits to the captured video are based on edits made to the edited image by the user. The image editor streams the edited video as the captured video is edited.

### BACKGROUND

A webcam is a video camera that captures and streams images through a computer or computer network. Webcams are often used for video telephony. Many desktop computer displays, laptop computers, computer tablets and smart phones come with a built-in camera and microphone.

### BRIEF DESCRIPTION OF THE DRAWINGS

FIG. 1 illustrates vanity lighting for a computer display in accordance with an implementation.

FIG. 2 shows a custom color menu window in accordance with an implementation.

FIG. 3 is a simplified block diagram of a computer system with vanity lighting in accordance with an implementation.

FIG. 4 is a simplified flowchart illustrating selection of vanity lighting for a computer display in accordance with an implementation.

FIG. 5 and FIG. 6 are simplified diagrams illustrating vanity lighting incorporated into a case for a tablet computer in accordance with an implementation.

FIG. 7, FIG. 8, FIG. 9 and FIG. 10 show vanity lighting retrofit to a system that uses a computer tablet in accordance with an implementation.

FIG. 11 and FIG. 12 show vanity lighting retrofit to a system that uses a smart phone in accordance with an implementation.

FIG. 13 is a simplified flowchart illustrating image editing and editing extrapolation in accordance with an implementation.

FIG. 14 is a simplified flowchart illustrating image editing and editing extrapolation for the background to a video conference in accordance with an implementation.

FIG. 15 is a simplified flowchart illustrating image editing and editing extrapolation for the user or the user and the background to a video conference in accordance with an implementation.

FIG. 16 is a simplified block diagram illustrating image editing and editing extrapolation illustrating image editing and editing extrapolation in accordance with an implementation.

### DESCRIPTION OF THE EMBODIMENT

To allow a user of a display to enhance their appearance as recorded by a video camera, vanity lighting can be added to the display. For example, this is accomplished by vanity lights arranged to produce vanity lighting that illuminates the user of the display. Selection of a lighting scheme produced by the vanity lights is responsive to user selections made using a computing device. A vanity light is a light placed above, below or along side of a display to illuminate a user of the display. In addition to lighting up a user, the vanity lighting can light up and subject placed before the display. In addition to the user, the subject could be a product on display or any other type of subject before the display.

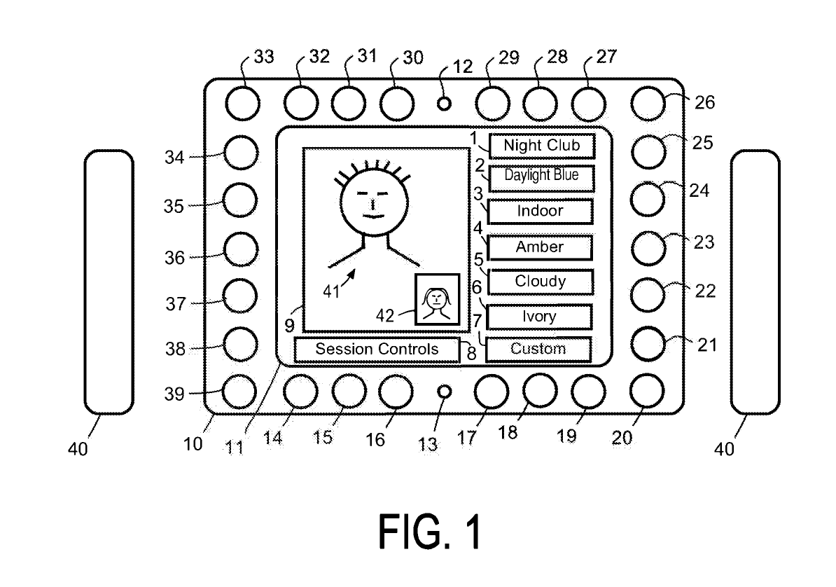

FIG. 1 shows a computer display 10 for a computing device. For example, computer display 10 is a stand-alone computer, a computer monitor integrated with a computer, a display for a laptop computer, or a display for a handheld device such as a computer tablet or a smart phone. A display screen 11 shows text and graphics output from a computing device such as a desktop computer, a laptop computer, a tablet computer or a smart phone. The casing for display 10 incorporates a video camera 12 and a microphone 13. Alternatively, video camera 12 and microphone 13 are stand-alone. Speakers 40 can also be incorporated within the casing for display 10 or stand-alone as shown in FIG. 1.

While video camera 12 is shown as a traditional video web camera, to allow the appearance of eye-to-eye contact, a multi-lens array can be used. For example, a NanoCam™ ultra-miniature lens array 3D camera from nanoLight Technologies LLC could be arranged on casing for display 10 to produce the effect of eye-to-eye contact.

Vanity lights can be attached to display 10 or can be integrated into casing for display 10 as shown in FIG. 1. For example, FIG. 1 shows a vanity light 14, a vanity light 15, a vanity light 16, a vanity light 17, a vanity light 18, a vanity light 19, a vanity light 20, a vanity light 21, a vanity light 22, a vanity light 23, a vanity light 24, a vanity light 25, a vanity light 26, a vanity light 27, a vanity light 28, a vanity light 29, a vanity light 30, a vanity light 31, a vanity light 32, a vanity light 33, a vanity light 34, a vanity light 35, a vanity light 36, a vanity light 37, a vanity light 38 and a vanity light 39 incorporated into casing of display 10.

Vanity lights 14 through 39 can be used to produce desired lighting effects as images of the face of a user are being captured by video camera 12. For example, vanity lights 14 through 39 are each an LED light that is able to produce multiple colored lighting. Alternatively, each of vanity lights 14 through 39 produces light of only one color and different colored light schemes are accomplished by activating differently colored lights from among lights 14 through 39.

For example, in FIG. 1, a graphic user interface (GUI) for a video teleconference is displayed on display screen 11. In a window 9 is displayed a graphic 41 for an image captured by another computer video camera. A window 42 shows an image captured by video camera 12. A user of display 10 can use the image displayed in window 42 to monitor how the user appears to others engaged in the video teleconference. Session controls 8 contain menu items that can be used to control the video teleconference. The menu items can include, for example, volume control, a mute feature, video pause, vanity lighting on, vanity lighting off, and so on.

A menu button 1, a menu button 2, a menu button 3, a menu button 4, a menu button 5, a menu button 6 and a menu button 7 are used to select coloring, brightness and so on for the vanity lighting provided by vanity lights 14 through 39. Menu buttons 1 through 6, for example, each activate a predetermined lighting scheme produced by vanity lights 14 through 39. Menu button 8 brings up a custom color menu window that allows the user to adjust the color scheme produced by vanity lights 14 through 39.

In addition to changing lighting effects, real time editing of images captured by video camera 12 can also be accomplished, as further described herein. For example, a frame captured by video camera 12 can be captured and displayed within window 9. The modifications can then be made directly to the captured image. For example, changes include changes to coloring, texture, shape and so on. This can have many uses.

For example, coloring of a captured frame can be changed to show the effects of adding cosmetics such as lipstick, mascara, rouge, etc. The effects can be added, for example, using standard features such as those included in video editing applications and drawing applications. For example, to represent the application of lipstick, the color of lips in the video can be edited to change to different colors representing the lip stick. Virtual mascara, rouge, base and so on can be likewise added to show the effects produced by cosmetics virtually, without having to actually apply the cosmetics to the person.

Additionally, changes to the image can be performed to represent effects of cosmetic surgery, removal of wrinkles and so on. This allows virtual viewing of changes before the changes are actually made.

In some embodiments, the changes can to the captured image can be extrapolated to the remainder of the video. Provided there is sufficient processing power, the video can be modified in real time. For example, once color of lipstick is modified on in a captured image, the modification can be carried over to later captured video in real time. For example, a user can capture an image of her visage from video camera 12, modify the color of lipstick, etc. then restart video capture. In the newly captured video, the color of lipstick is changed on the fly to match the modified color of lipstick. This modified captured image can then be used in a video conference so that within the video conference, the user will appear with the modified coloring to lipstick, and so on.

In addition to changes visual, other changes can be made as well. For example, changes can be made to sound. This allows for a user to change, for example, pitch, tone, resonance, etc., of captured sound that is broadcast over a video conference.

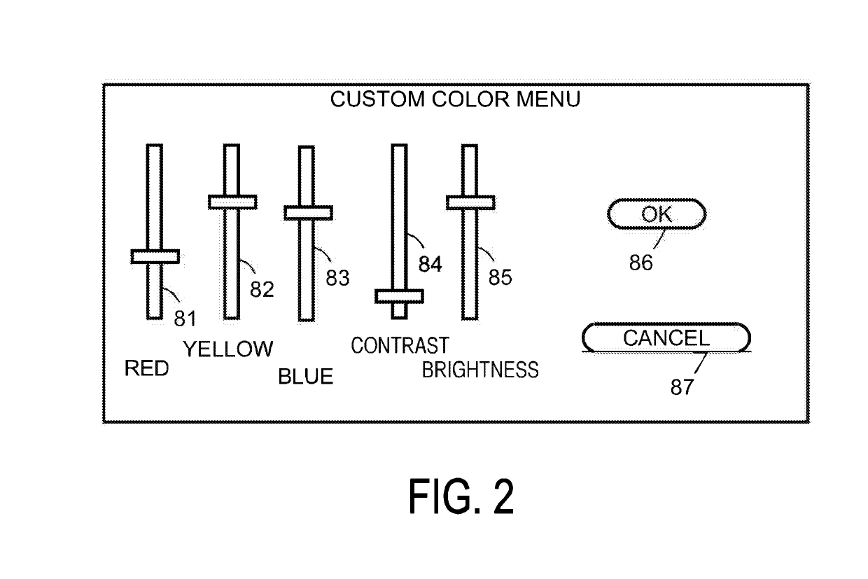

FIG. 2 shows an example of a custom color menu window 80 that allows the user to adjust the color scheme produced by vanity lights 14 through 39. For example, a control 81 allows adjustment to increase or decrease red lighting. A control 82 allows adjustment to increase or decrease yellow lighting. A control 83 allows adjustment to increase or decrease blue lighting. A control 84 allows adjustment to increase or decrease color contrast. A control 85 allows adjustment to increase or decrease brightness. An OK button 86 allows a user to accept current values selected custom color menu window 80. A cancel button 87 allows a user to return without making changes to the color scheme produced by vanity lights 14 through 39. Additional controls can be used to virtually change appearance or tones. For example, image editing and drawing controls can be added such as those available in commercially available image editing and drawing applications. Sound controls for pitch, tone, resonance can also be added.

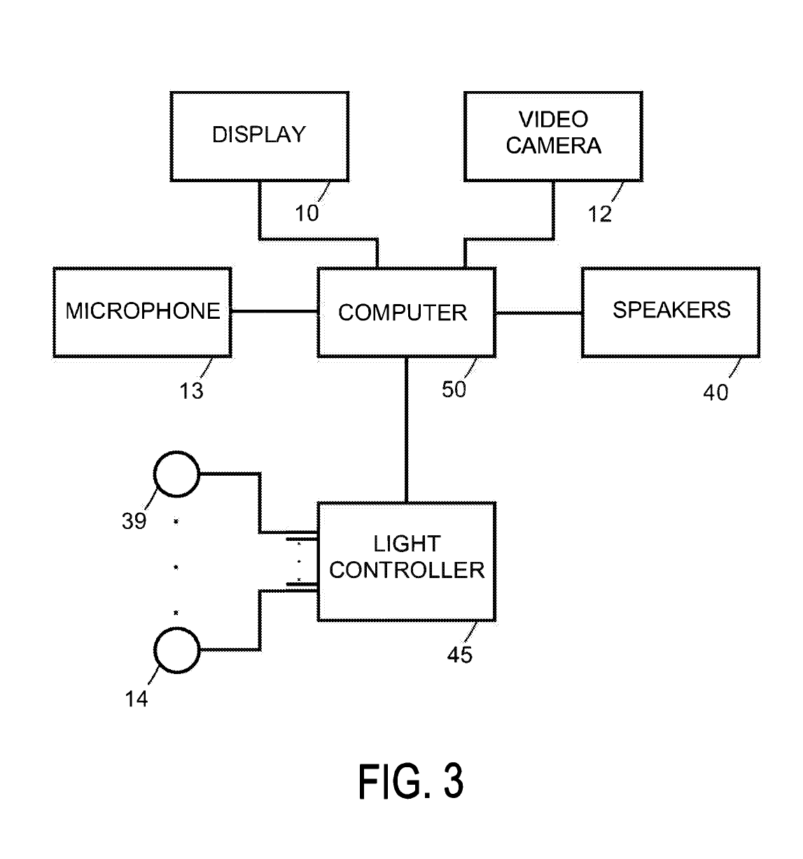

FIG. 3 is a simplified block diagram showing a computer 50 connected to a display 10, a video camera 12, speakers 40 microphone 13 and a light controller 45. Light controller 45 controls vanity lights 14 through 39. For example, the interface between computer 50 and light controller 45 is a universal serial bus (USB) interface. Alternatively, another wired or wireless interface (such as Bluetooth wireless interface) can be used to connect computer 50 to light controller 45. Based on instructions from computer 50, light controller 45 turns on and off combinations of vanity lights from vanity lights 14 through 39. If each of vanity lights 14 can display more than one color, control signals from light controller 45 select which colors are displayed. When it is possible to vary intensity of light generated by individual vanity lights 14 through 39, control signals from light controller 45 indicate intensity of light emitted from each of vanity lights 14 through 39.

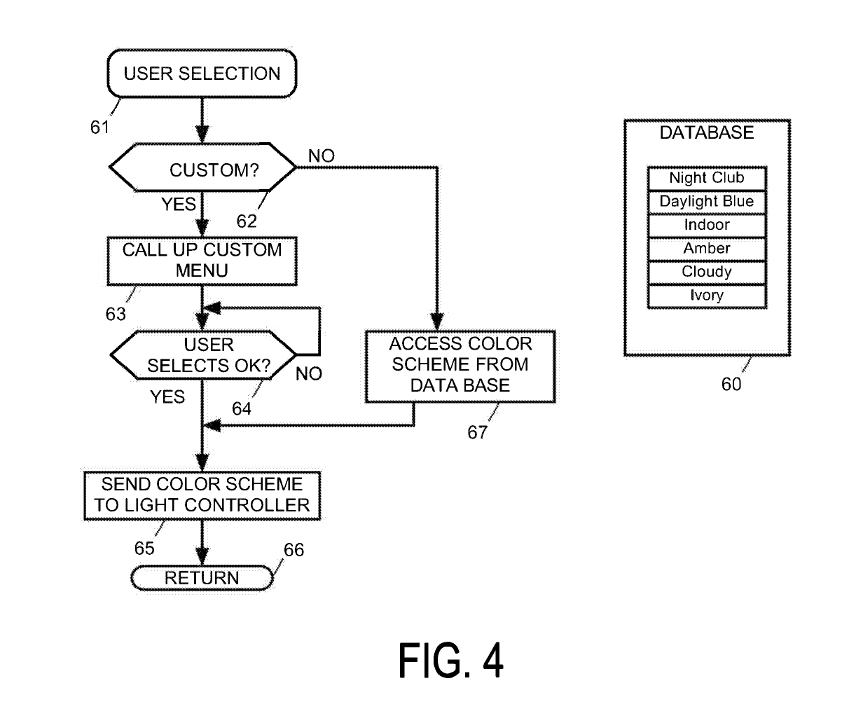

FIG. 4 is a simplified flowchart illustrating selection of vanity lighting for a computer display in accordance with an implementation. In a block 61, a user makes a selection. For example, the user selects one of menu buttons 1 through 7. In a block 62, a check is made to see if menu button 7 for custom lighting is selected. If so, in a block 63, custom color menu window 80 is displayed to the user. The user is then allowed to adjust controls to configure custom vanity lighting. In a block 64, the logic flow waits until user selects OK button 86. When the user selects OK button 86, in a block 65, the color scheme is sent to light controller 45 for application to vanity lights 14 through 39. Then, in a block 66, logic flow returns to a calling process. Also, whenever the user selects cancel button 87 shown in FIG. 2, logic flow returns to a calling process.

If in block 62, a menu button aside from menu button 7 is selected, the color scheme is accessed from a database 60. For example, if the user selects menu button 1, then control signals for a night club lighting scheme are accessed from database 60. If the user selects menu button 2, then control signals for a daylight blue lighting scheme are accessed from database 60. If the user selects menu button 3, then control signals for an indoor lighting scheme are accessed from database 60. If the user selects menu button 4, then control signals for an amber lighting scheme are accessed from database 60. If the user selects menu button 5, then control signals for a cloudy lighting scheme are accessed from database 60. If the user selects menu button 6, then control signals for an ivory lighting scheme are accessed from database 60. In block 65, the color scheme is sent to light controller 45 for application to vanity lights 14 through 39. Then, in a block 66, logic flow returns to a calling process. The preset lighting schemes illustrated by menu buttons 1 through 6 are just exemplary. Various other preset lighting schemes could be used. For example, there could be an outdoor lighting scheme with amber lighting on the left and straw lighting on the right. There could be an outdoor lighting scheme with straw lighting on the left and amber lighting on the right. There could be different white colors, such as ivory white and silk white. There could be greeting tinting, red tinting or pink tinting to accommodate various desired ambiences. And so on.

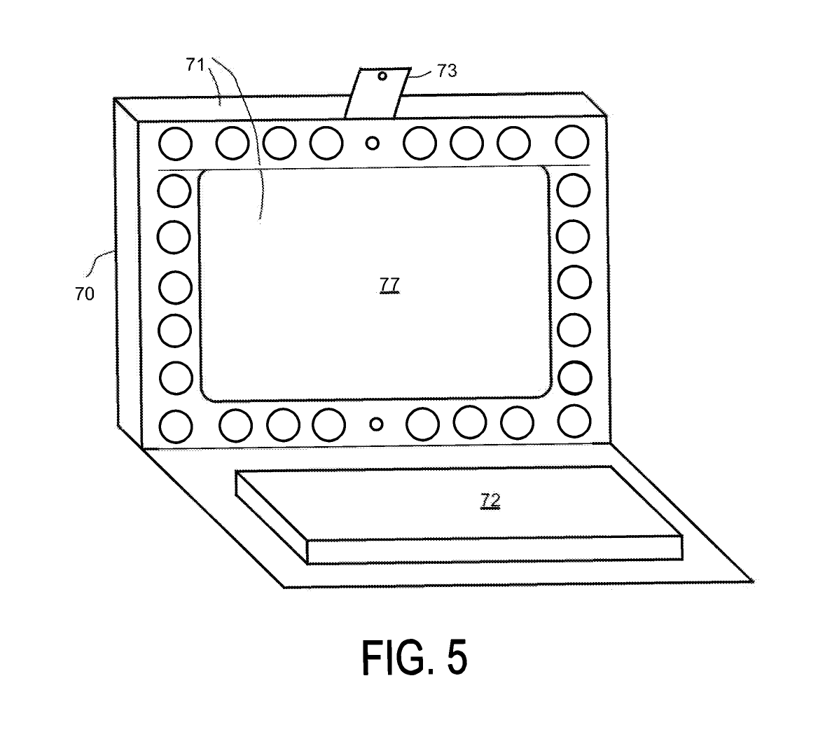

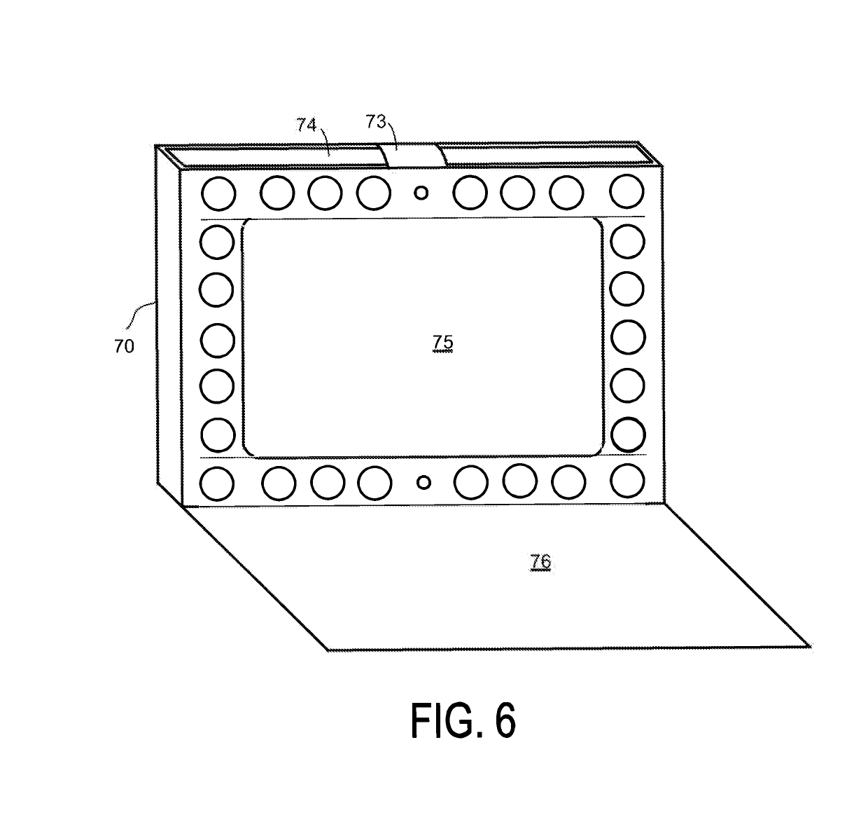

In one implementation, a mirror and/or an optional make-up tray can be used in conjunction with computer display 10 to allow a user to conveniently have access to make-up in order to enhance facial appearance. For example, a case for a tablet computer includes an attachable make-up tray, a mirror and vanity lights 14 through 39. Light controller 45 is integrated within the case and connected to the electronics of the tablet computer via a hard wire connection (such as USB) or a wireless connection (such as a Bluetooth connection). In one configuration (e.g., when the tablet computer is removed from the case) the user can use the mirror and vanity lights 14 through 39 to apply make-up. In another configuration (e.g., when the tablet computer is returned to the case and covers the mirror), the vanity lights are used to illuminate the user as images of the user are captured by video camera 12. Other features, such as a keyboard, can also be added to the case of the tablet. FIG. 5 and FIG. 6, for example, illustrate this.

In FIG. 5, a case 70 for a tablet computer includes an attachable make-up tray 72 and vanity lights. A make-up tray 62 can be attachable as shown. When there is no table computer inside case 70, a mirrored surface 71 on a backing of case 70 is visible through an opening 77. Light controller 45 is integrated within case 70 and connected to the electronics of the tablet computer via a hard wire connection (such as USB) or a wireless connection (such as a Bluetooth connection). In this configuration, the user can use mirrored surface 77 when applying make-up.

In FIG. 6, a tablet computer 74 has been placed in case 70 and secured by a strap 73. Through opening 77, the user can see a screen display 75 of tablet computer 74. A bottom region 76 of case 70 can be, for example, a flat surface or contain a keyboard. In this configuration, the vanity lights can be used to illuminate the user as images of the user are captured by a video camera.

Similar cases can be designed for a smart phone or a computer laptop.

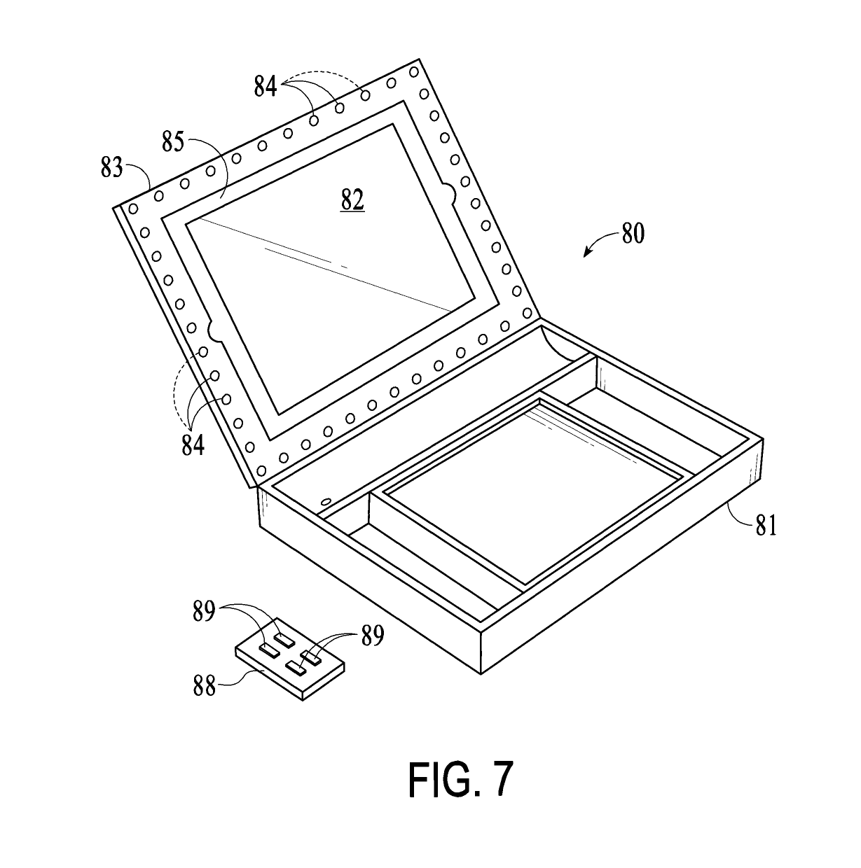

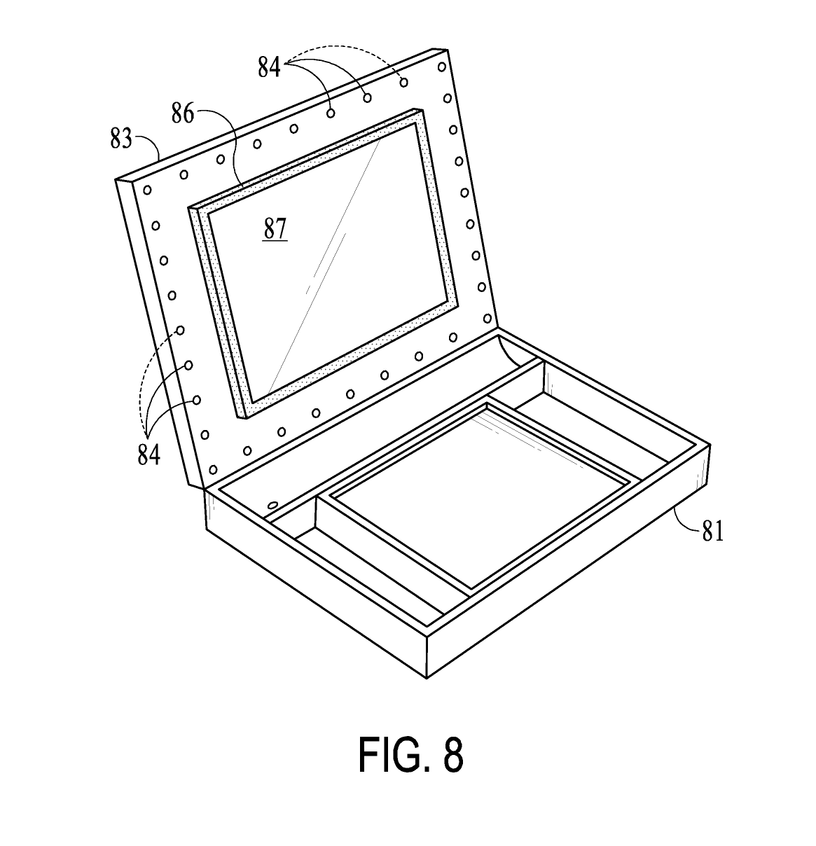

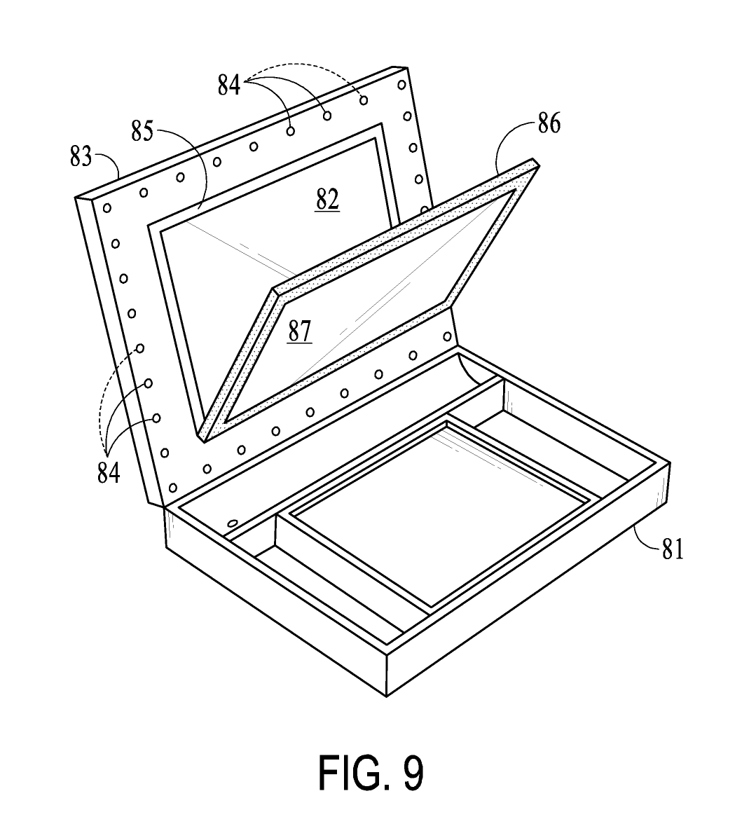

FIG. 7, FIG. 8, FIG. 9 and FIG. 10 show vanity lighting retrofit to a system that uses a computer tablet. In FIG. 7, a computer tablet 85 is mounted into a frame 83 of a box 80. A screen 82 of computer tablet 85 is visible when box 80 is open. For example, a bottom 81 of box 80 can be configured to hold make-up, or some other contents. Vanity lighting 84 is controlled by computer tablet 85 or alternatively (or in addition) by a remote 88. For example, buttons 89 can control, color selection, pattern selection, brightness and power on/off for vanity lighting 84.

FIG. 8 shows a mirror 87 held by a mirror frame 86 that can be mounted over computer tablet 85. FIG. 9 shows how mirror and mirror frame 86 can either be folded down or detached to reveal screen 82 of computer tablet 85.

FIG. 7 and FIG. 9 show computer tablet 85 mounted on frame 83 in a landscape orientation. FIG. 10 shows vanity lighting retrofit to a system that mounts a computer tablet 95 in a portrait orientation. Specifically, in FIG. 10, computer tablet 95 is mounted into a frame 93 of a box 90. A screen 92 of computer tablet 95 is visible when box 90 is open. For example, a bottom 91 of box 90 can be configured to hold make-up, or some other contents. Box object 96 and box 97 can represent, for example, circuitry or power supply for vanity lighting 94.

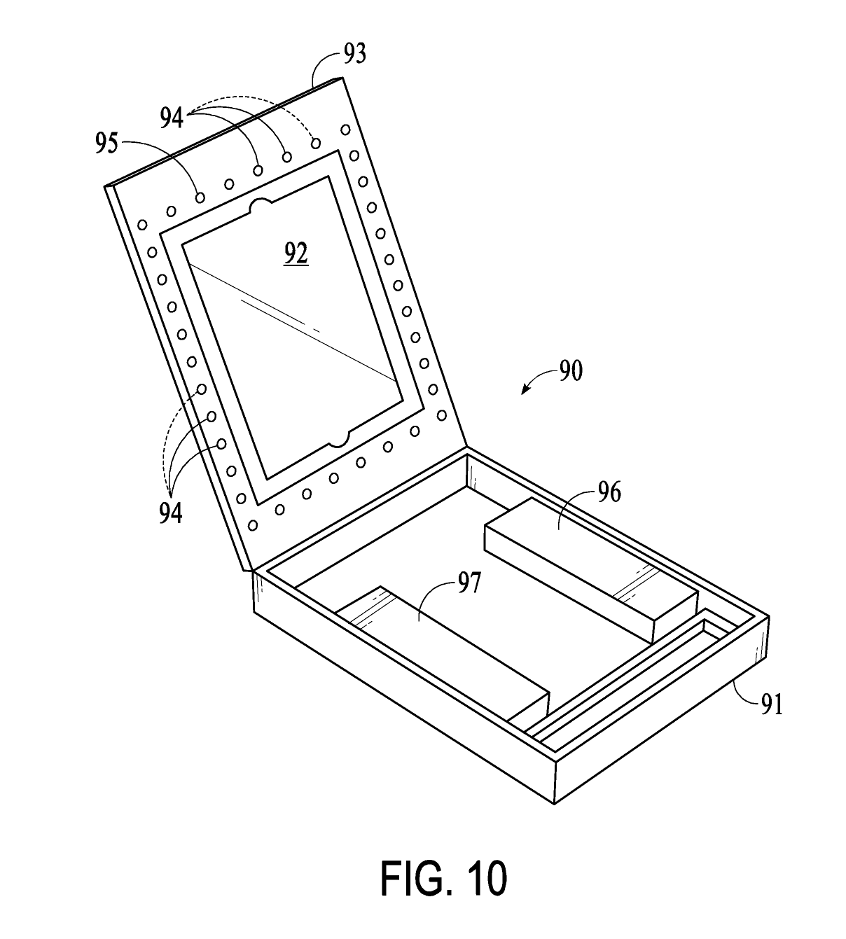

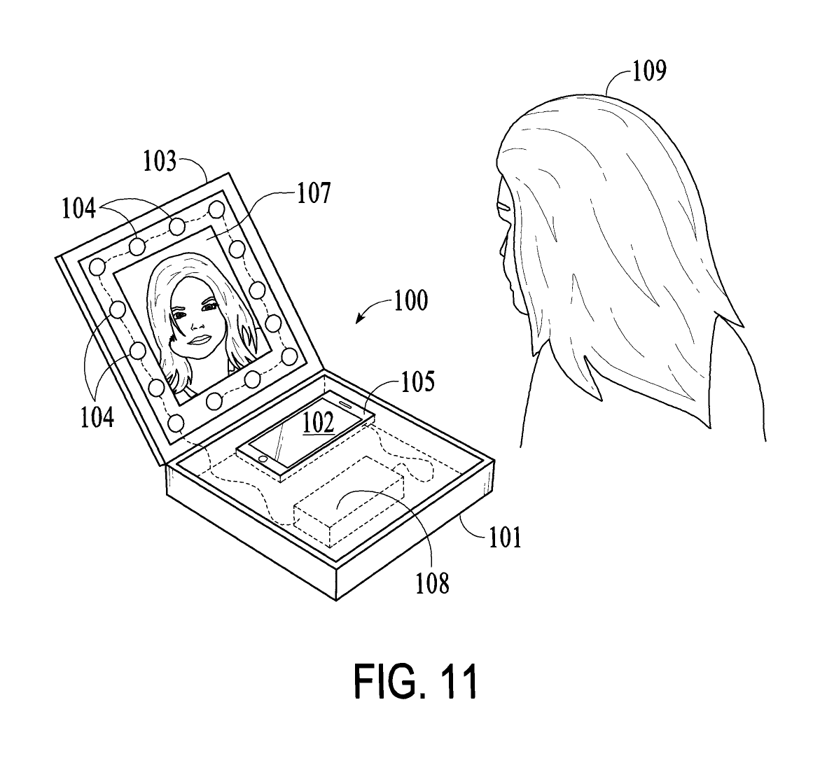

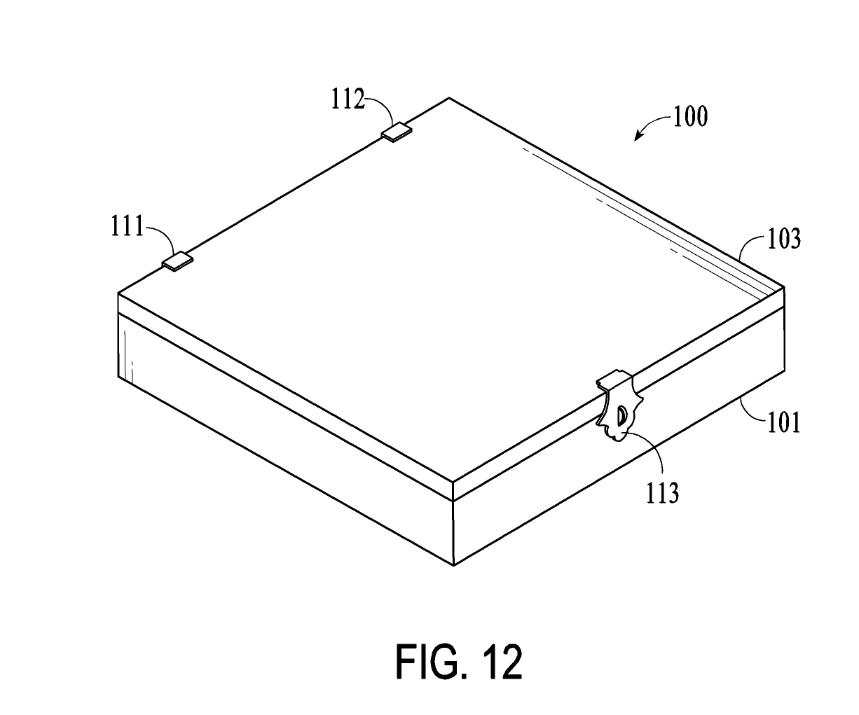

FIG. 11 and FIG. 12 show vanity lighting retrofit to a system that uses a smart phone. In FIG. 11, a smart phone 105 is mounted within a bottom 101 of box 100. A screen 102 of smart phone 85 is visible when box 100 is open. For example, bottom 101 of box 100 can be configured to hold make-up, or some other contents. Vanity lighting 104 is controlled by smart phone 105 or alternatively (or in addition) by a remote. A mirror 107 is mounted within a top 103. In FIG. 11, a reflection of the face of a user 109 is shown being reflected by mirror 107. Box shaped object 108 contains, for example, circuitry and/or power supply for vanity lighting 94.

FIG. 12 shows box 100 in a closed position. Hinges 111 and 112 as well as clasp 113 are shown securing top 103 to bottom 101 of box 100.

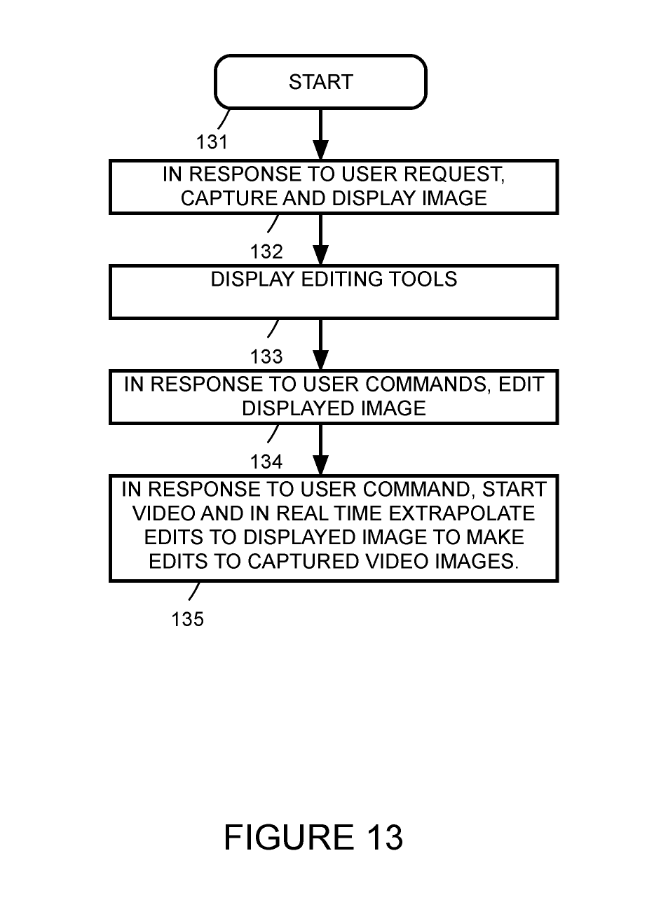

FIG. 13 is a simplified flowchart illustrating image editing and editing. In a block 131, a start is made. For example, the start results when a user turns on a video recorder and begins capturing video. When the video camera is pointed at the user, images of the user may be captured.

In a block 132, in response to a user request, an image is captured and displayed. For example, the image may include the user. In a block 133, editing tools are displayed allowing the user to edit the image. The editing tools, as described above, may include tools to change colors and shapes within the captured image. The editing tools can additionally include any known image editing tools or drawing tools.

In a block 134 the displayed image is edited in response to user commands based on the use of the image editing tools. In a block 135, in response to a further user command, video capture starts, or resumes. The video is automatically edited in real time as the video is captured to extrapolate the edited changes to the displayed image unto the captured video. That is changes to the capture video images are made based on, and reflective of, the changes in lighting, shapes and so on made to the previously displayed image.

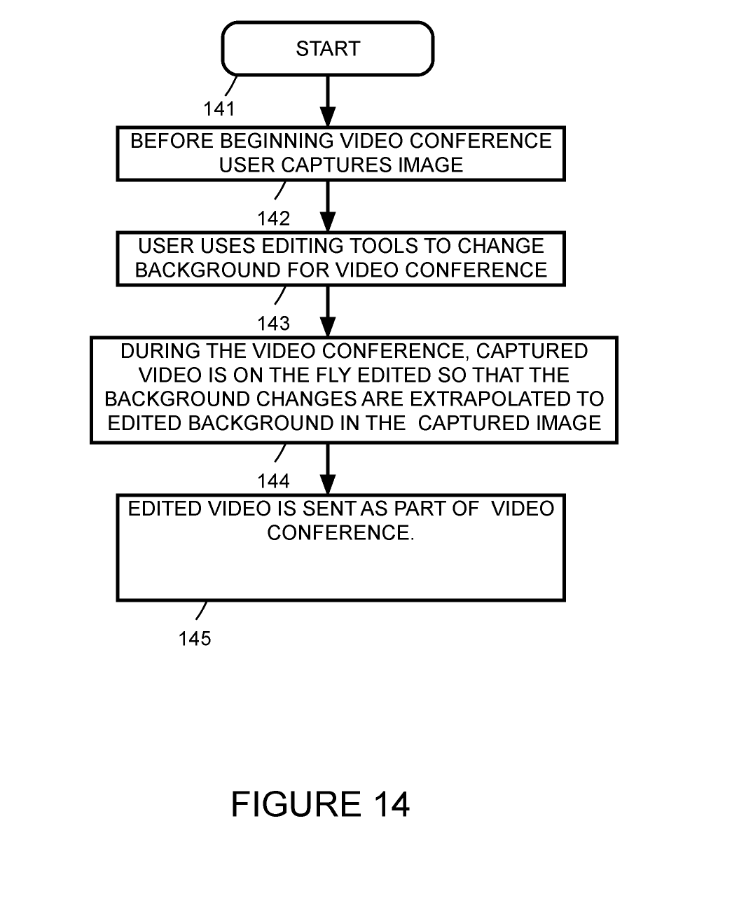

The ability to change the ability of one image and having the changes extrapolated to a video recording can be beneficial in a number of applications. For example, before starting a video conference, a user can change the background for the video conference and thus customize the background appearance during the video conference. This is illustrated by the flowchart in FIG. 14.

FIG. 14 shows in a block 141, a start is made. For example, the start results when a user turns on a video recorder and captures an image. The image can be captured as a single image, or can be selected from a series of images captured in a video recording. For example, the image can include just the background or can include the user and the background.

In a block 142, the user uses editing tools to change the background for the video to be captured. For example, the user changes something as simple as the background colors. Alternatively, the user can add or remove features to the background. In a block 144, during the video conference, captured video is on the fly edited by the system to match the background changes made to the originally captured and edited image. In a block 145, during the video conference, the edited video with the changed background is sent. This allows the user to change the background that is seen during the video conference.

For example, before starting a video conference, a user can change the user's appearance for the video conference and thus customize the appearance during the video conference. This is illustrated by the flowchart in FIG. 14.

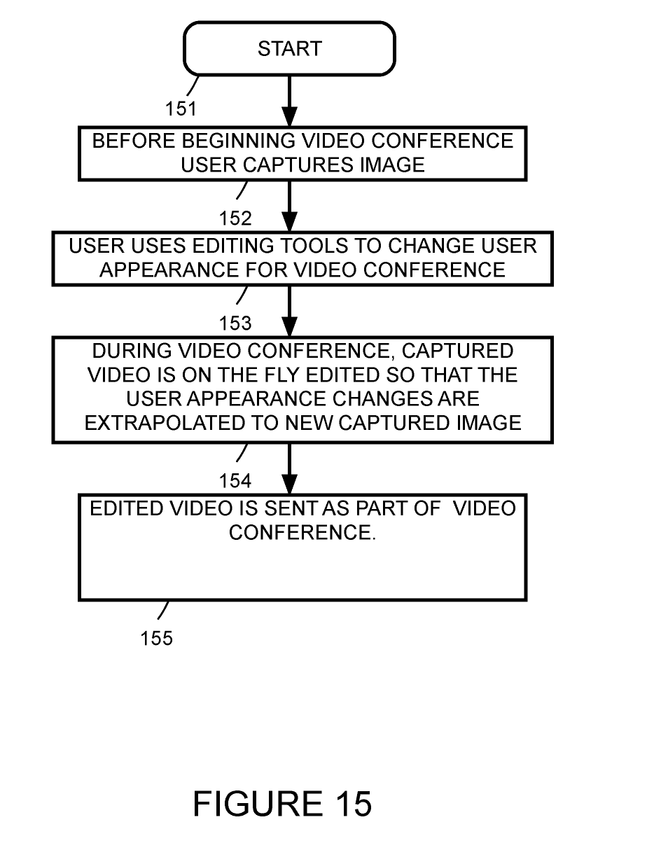

FIG. 15 shows in a block 151, a start is made. For example, the start results when a user turns on a video recorder and captures an image. The image can be captured as a single image, or can be selected from a series of images captured in a video recording. The image includes the user and the background.

In a block 152, the user uses editing tools to change the appearance of the user or both the user and the background for the video to be captured. For example, the user changes something as simple as the colors of clothes, hair or eye color. Alternatively, the user can adjust features such as removing wrinkles, adding virtual makeup and other changes. In a block 154, during the video conference, captured video is on the fly edited by the system to match the changes made to the originally captured and edited image. In a block 155, during the video conference, the edited video with the changes made is sent. This allows the user to change the user appearance or the user appearance and background that is seen during the video conference.

While in the above examples the video is used for a video conference, in other implementations the video may be used for other purposes. For example, the video can be immediately played back to the user as a virtual mirror. This would allow the user to virtually try out make-up, clothes, including hats, hair colors and other looks and to see how this appearance would look not just in a still image but with movement in a video.

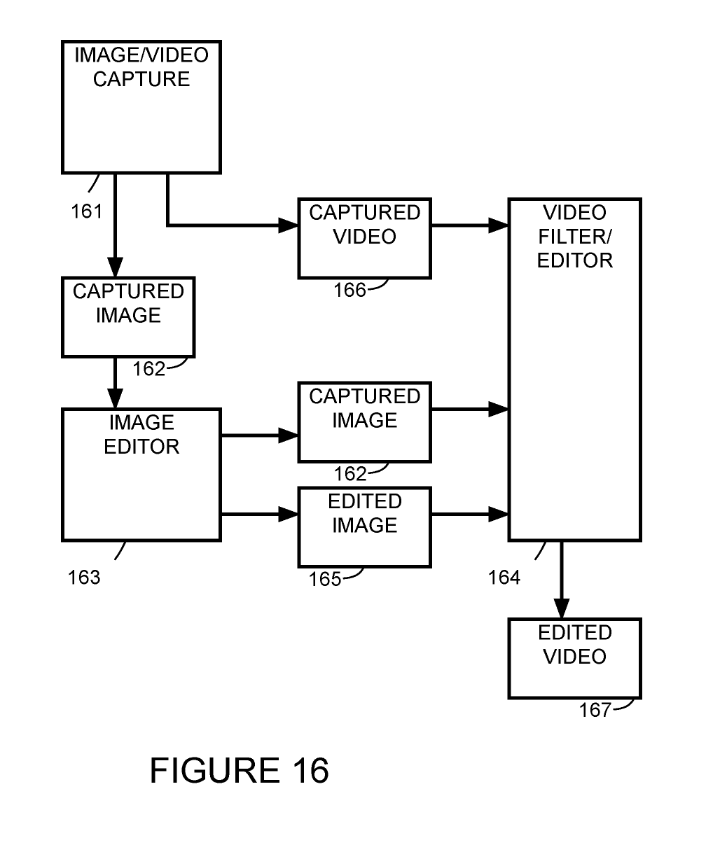

FIG. 16 shows an image and video capture device 163 such as a video and image camera available on a computing device such as a personal computer, tablet computer or smart phone. An image editor 163 receives a user selected captured image 162 from the image/video capture device 161. Image editor 163, in response to selections from the user, produced an edited image 165. Image editor 163 send the original captured image 162 and edited image 165 to a video filter and editor 164. When image/video capture 161 produces additional captured video 166, for example, during a video conference, video editor 164 takes into account the differences between captured image 162 and edited image 165 to edit captured video 166 to produce edited video 167 that can be used in the video conference, or for other uses as described above.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention.

What is claimed is:

1. A method to generate edited video, the method comprising:
in response to a user request, capturing and displaying a captured image captured by a camera on a personal computing device;
displaying to the user, editing tools which the user can use to edit the captured image;
editing the captured image in response to user commands to produce an edited image;
sending the edited image to a video editor;
capturing video by the camera on the personal computing device;
sending the captured video to the video editor;
editing the captured video in real time by the video editor to produce the edited video, wherein edits to the captured video are based on edits made to the edited image; and,
streaming the edited video as the captured video is edited.

2. A method as in claim 1, wherein the personal computing device is a desk computer, a portable computer, a tablet computer or a smart phone.

3. A method as in claim 1, wherein the edited video is streamed to a video conference.

4. A method as in claim 1, wherein the edited video is streamed back to the user to provide a virtual mirror.

5. A method as in claim 1 wherein the captured image is edited to change appearance of a background of the captured image.

6. A method as in claim 1 wherein the captured image is edited to change appearance of the user.

7. A method as in claim 1 wherein the captured image is edited to change both appearance of a background of the captured image and appearance of the user.

8. A method as in claim 1 wherein the video editor also receives the captured image and uses the captured image to detect edits made to the edited image.

9. A video system to generate edited video, the system comprising:
a camera on a personal computing device that is able to capture both a captured image and captured video;
an image editor that includes editing tools by which a user can edit the captured image;
a video editor configured to edit the captured video in real time by the video editor to produce the edited video, wherein edits to the captured video are based on edits made to the edited image by the user, the image editor streaming the edited video as the captured video is edited.

10. A video system as in claim 9, wherein the personal computing device is a desk computer, a portable computer, a tablet computer or a smart phone.

11. A video system as in claim 9, wherein the edited video is streamed to a video conference.

12. A video system as in claim 9, wherein the edited video is streamed back to the user to provide a virtual mirror.

13. A video system as in claim 9, wherein the captured image is edited to change appearance of a background of the captured image.

14. A video system as in claim 9, wherein the captured image is edited to change appearance of the user.

15. A video system as in claim 9, wherein the captured image is edited to change both appearance of a background of the captured image and appearance of the user.

16. A video system as in claim 9, wherein the video editor also receives the captured image and uses the captured image to detect edits made to the edited image.

17. A video system as in claim 9, wherein the personal computing device includes vanity lighting.
